(19) United States
(12) Patent Application Publication
(10) Pub. No.: US 2007/0215351 A1
(43) Pub. Date: Sep. 20, 2007

(54) Use of phosphorus and nitrogen containing formulations in secondary oil recovery operations

(75) Inventors: Sam Wernli, Houston, TX (US); C. Edward Baxter JR., League City, TX (US)

Correspondence Address: BRACEWELL & GIULIANI LLP, P.O. BOX 61389, HOUSTON, TX, 77208-1389, US

(73) Assignee: EnviroFuels, LLC, Houston, TX (US)

(21) Appl. No.: 11/700,641

(22) Filed: Jan. 31, 2007

Related U.S. Application Data
(60) Provisional application No. 60/763,588, filed on Jan. 31, 2006.

(51) Int. Cl. E21B 43/22; C09K 8/58

(52) U.S. Cl. 166/275; 166/305.1; 166/307; 507/267; 507/274; 507/236; 507/240; 507/936; 507/937

(57) ABSTRACT

The present invention relates to the field of additives to enhance secondary oil recovery to improve oil production. The additive is an inorganic nitrogen and phosphorus-containing composition that can be added to, or in conjunction, with the injection water.

### RELATED APPLICATIONS

This application is related to and claims priority and benefit of U.S. Provisional Patent Application Ser. No. 60/763,588, filed Jan. 31, 2006, titled “The Use Of Phosphorus And Nitrogen Containing Formulations In Secondary Oil Recovery Operations,” which is incorporated herein by reference in its entirety.

### TECHNICAL FIELD OF THE INVENTION

The present invention relates to formulations containing inorganic phosphorus and nitrogen compounds for use in secondary oil recovery operations.

### BACKGROUND OF THE INVENTION

Crude oil development and production in U.S. oil reservoirs can include up to three distinct phases: primary, secondary, and tertiary (or enhanced) recovery.

During primary recovery, the natural pressure of the reservoir or gravity drive oil into the wellbore combined with artificial lift techniques (such as pumps) which bring the oil to the surface. But only about 10 percent of a reservoir's original oil in place is typically produced during primary recovery. Shortly after World War II, producers began to employ secondary recovery techniques to extend the productive life of U.S. oil fields, often increasing ultimate recovery to 20 to 40 percent of the original oil in place. For the most part, these techniques have involved injecting water to displace oil and drive it to a production wellbore. In some cases, the reinjection of natural gas has been employed to maintain reservoir pressure (natural gas is often produced simultaneously with the oil from a reservoir).

However, as the well recovery reaches the 20-40 percent level, secondary recovery using water injection becomes less efficient as the injected water takes the path of least resistance and begins to flow into the empty pores in the formation thus reducing the amount of oil pushed through the formation to the wellhead.

As a result, producers have attempted several tertiary, or enhanced oil recovery (EOR), techniques that offer prospects for ultimately producing 30 to 60 percent, or sometimes more, of the reservoir's original oil in place. These techniques include thermal recovery (steam injection), chemical injection and gas (CO2) injection.

However, each of these techniques has been hampered by its relatively high cost and, in some cases, by the unpredictability of its effectiveness. A modified secondary recovery technique, therefore, is needed in which water injection can be made to be more efficient and thus more economical than the EOR processes.

Other techniques have also been used such as polymers and gelled or crosslinked water-soluble polymers for enhanced oil recovery and other oil field operations. They have been used to alter the permeability of underground formations in order to enhance the effectiveness of water flooding operations. Generally, polymers or polymers along with a gelling agent such as an appropriate crosslinking agent in a liquid are injected into the formation. Such systems are also expensive processes and may produce undesired effects.

U.S. Pat. No. 6,225,263 teaches a method of increasing the recovery of oil and/or gas from an underground formation by injecting into the formation an aqueous solution of a mono alkyl ether of polyethylene glycol.

U.S. Pat. No. 3,902,557 describes a method of treating the formation surrounding a well by injection of a solvent including a C₄ to C₁₀ alkyl ether of a polyglycol ether containing a C₄ to C₁₀ alkyl ether of a polyglycol ether containing 10-22 carbon atoms per molecule. C₄ to C₈ monoalkyl ethers of tri and tetra ethylene glycols are preferred in particular the hexyl ether while the butyl ether is also mentioned. The solvent may be diluted with an organic liquid such as alcohol, e.g. isopropanol.

It would be advantageous to provide a recovery process that is cost effective. It would be advantageous to use commercially available traditional injection facilities to reduce capital expenditures.

### SUMMARY OF THE INVENTION

We have now found that certain mixtures of aqueous inorganic salt solutions or non-aqueous dispersions of inorganic salts, containing phosphorus and nitrogen can be used in conjunction with water injection to increase effectiveness of the water injection and thereby increase production oil. The present invention is comprised of an additive for secondary oil recovery and method of using the additive in conjunction with secondary oil recovery processes, including water injection.

The additive of the invention includes an inorganic phosphorus and nitrogen-containing parent solution containing [Y]H₂PO₄, and [Y] ₂HPO₄, where Y is a cation. Y does not have to be the same cation in both salt compounds. The additive is operable to be dispersed within a dispersion fluid. A preferred dispersion fluid is water and can be injection water. The cationic portion of the salt components can be any cation, with potassium being a preferred cation. In this case, the preferred components would be KH₂PO₄, K₂HPO₄. Another group of preferred cations would be ammonium compounds, the alkali metals or Group IA elements. When the additive is prepared using ammonium compounds, ammonium compounds being defined as those compounds containing NHx groups, the nitrogen in the solution is essentially all in the form of ammonium ions. There is at most a negligible amount of free ammonia such that the solution is substantially without free ammonia. In a preferred embodiment, the solution has a pH between about 6.0 and 8.0. Advantageously, the use of halogens, such as chlorine and fluorine, is also avoided.

In addition to the phosphoric acid derived anions, a preferred embodiment includes [NR₄]H₂PO₄ wherein R is selected from the group consisting of hydrogen, alkyl groups and combinations thereof. Another preferred embodiment includes the use of [NR₄] ₂HPO₄. Still another preferred embodiment includes both [NR₄]H₂PO₄ and [NR₄] ₂HPO₄. Examples where R is hydrogen include [NH₄]H₂PO₄, and [NH₄] ₂HPO₄.

In addition to the phosphoric acid derived anions, organic acid anions can also be present, preferably lower organic acids with a carbon number less than 5 and most preferably acetic acid.

The salts can be made in-situ by mixing of the corresponding acids and bases in an aqueous matrix so as to form the aqueous parent solution containing inorganic phosphorus and nitrogen. The water acts as a solvent. Other preferred parent solution solvents include alcohols.

Similarly, the parent solution can be dehydrated to minimize volume for transportation and then added to the dispersion fluid, such as injection water, on site. Alternately, the oil recovery additive can be added to a carrier fluid such that a water in oil emulsion is created.

One preferred embodiment includes adding the inorganic phosphorus and nitrogen compounds as preformed salts of phosphoric acid in the presence of water to create the phosphorus-containing parent solution as an aqueous parent solution. Other preferred parent solution solvents include alcohols.

The aqueous parent solution can also contain preformed salts of organic acids, preferably lower organic acids with a carbon number of 5 or less, most preferably acetic acid.

Preferred cations for the preformed salts are ammonium compounds, alkali metals and Group IA elements.

Another preferred embodiment of the phosphorus-containing parent solution includes the addition of [Y]PO₄ to the [Y]H₂PO₄, and [Y] ₂HPO₄ and contained ammonium equivalents.

Another preferred embodiment of the phosphorus-containing parent solution includes the addition of [NH₄]PO₄ to the [Y]H2PO₄, and [Y] ₂HPO₄ and contained ammonium equivalents.

While orthophosphoric acids have been described, also called phosphoric acids, this includes pyrophosphoric acids, which are the condensed analogs of orthophosphoric acid. The difference being that, through the process to condense the orthophosphoric acid, the PO₄³⁻ becomes P₂O₇²⁻ or other condensed phosphates. Therefore, [Y] H₂PO₄, and [Y] ₂HPO₄ are precursors to pyrophosphoric acids. The use of the pyrophosphoric and other condensed forms is therefore encompassed within the definition of the orthophosphate form.

Included in the invention is a process for improving the performance of secondary oil recovery involving the steps of providing to a formation or strata the additive described above in an amount effective to increase oil production

In one embodiment of the invention the additive is utilized by adding it to the injection water used for secondary oil recovery in an amount or proportion effective to stimulate increased oil production. A preferred embodiment includes the addition of between about 1 to 40,000 ppm phosphorus and 1 to 40,000 ppm nitrogen into the injection water though the addition of the additive. More preferably, the enhanced injection water contains phosphorus in the range of 50 to 150 ppm by weight and nitrogen in the amount of between about 400 and 700 ppm by weight. Increased amounts of nitrogen and phosphorus are effective as well.

An alternate embodiment of the invention includes a process for enhancing performance of water injection used in secondary oil recovery including the steps of adding a chemical addition composition to the injection water in an amount effective to increase oil production. The chemical addition composition is created by (i) mixing in an aqueous medium a source of reactive NH₂ groups with one of the following:

(a) an alkali metal hydroxide to raise the pH of the solution above 12 to form an aqueous ammonium/alkali metal hydroxide; or

(b) a source of phosphoric acid to lower the pH of the solution to about 0 to form an acidic ammonium mixture.

The next step includes either combining the intermediate solution of step (i.a.) with the source of phosphoric acid; or the solution of (i.b.) with the hydroxide at a rate sufficient to create a highly exothermic reaction. This results in reactive NH₂ groups being contained in solution during the formation of the chemical addition composition. Organic acids can be present during the exothermic reaction or added post reaction to adjust pH to desired range

The parent solution, or the chemical addition composition of the invention, can be added directly to the injection water used in secondary oil recovery.

A composition of phosphoric acid, alkali metal hydroxide and a source of reactive NH2 groups has been explored in U.S. Pat. No. 5,540,788 for the creation of a metal conversion surface, the disclosure of the patent being incorporated herein by reference. The current invention includes the use of the conversion surface composition as an additive for secondary oil recovery. In one embodiment the additive is chemical addition composition for improvement of secondary oil recovery where the chemical addition composition has the composition disclosed in U.S. Pat. No. 5,540,788.

In an alternate embodiment of the current invention, the chemical addition composition described above can be emulsified with a suitable hydrocarbon carrier fluid. The emulsified hydrocarbon carrier fluid, containing phosphorus and nitrogen in the desired proportions, can be used separately or in conjunction with water injection. An example of these embodiments would be to inject the oil well with the emulsified carrier fluid either alone or in conjunction with other treatment chemicals. The injection method can be any technique that provides the additive to the formation or strata in an effective amount to increase productivity. Various injection techniques are known in the art. Similarly, the parent composition, preferably dehydrated, can be emulsified with the hydrocarbon carrier fluid. The emulsified hydrocarbon carrier fluid, containing phosphorus and nitrogen in the desired proportions, can be used separately or in conjunction with water injection

In another alternate embodiment of the invention, the emulsified carrier fluid can be dehydrated to produce a hydrocarbon carrier fluid dispersion containing the inorganic salts of nitrogen and phosphorus as stable dispersed particles. In an example of this embodiment the oil well can be injected with the inorganic phosphorus nitrogen containing dispersion prior to the water injection. The injection method can be any technique that provides the additive to the formation or strata in an effective amount.

In further alternate embodiment of the invention the emulsified carrier fluid or the hydrocarbon carrier fluid dispersion can be added in conjunction with, or as solutions with, other chemicals used in the oil recovery process including drilling mud, drilling fluids, surfactants and EOR chemicals and products. A particularly preferred embodiment is without added surfactants (i.e. surfactants not produced in situ).

An enhanced injection fluid comprising injection water and an oil recovery additive, the oil recovery additive comprising reaction products from mixing of a source of phosphoric acid, an alkali metal hydroxide, ammonium hydroxide and water, the oil recovery additive being operable to improve oil recovery in secondary oil recovery.

### DETAILED DESCRIPTION

Although not limited to any particular theory or concept, the additive of the current invention is believed to function in one or more of several ways;
(a) phosphorus and nitrogen can act as nutrients for indigenous subterranean microbes than can, with the proper nutrition, form a biomass that can plug pores in rock formations and strata and thus improve the efficiency of the water injection to increase oil production
(b) Phosphorus and nitrogen can act as nutrients for other indigenous microbes that can produce bio-surfactants that can reduce the affinity of the formation for the crude oil thus allowing for increased oil production.
(c) The phosphorus and nitrogen containing formulations including the aqueous parent solution and the non-aqueous carrier formulations interact with the formation or strata such that the oil is more easily released.

The preferred embodiment of the invention includes the use of the aqueous inorganic phosphorus and nitrogen containing parent solution by direct mixing with the injection water. One benefit of the inventive composition and related process is that non-productive formation pores are blocked or otherwise rendered inactive allowing the injection water to more efficiently force oil from productive pores in the formation.

An important aspect of this embodiment is that it is accomplished without wellbore face blocking. Wellbore face blocking can prevent treatment chemicals from properly entering the formation.

Another important aspect of the preferred embodiment is that the pH of the aqueous parent solution is near or at neutral. Strong acidic formulations of the prior art are avoided. Strong acid solutions can be very corrosive.

In another embodiment of the invention the contained oil is more efficiently released from the pores in the formation by treatment with the compositions of the invention. In this case the carrier fluid emulsion and the non-aqueous particle dispersion compositions are the most effective. Treatment can be by any know process in which the additive is contacted with the contained oil in an effective manner and concentration.

One example of a preferred formulation of the invention includes the following ratios: 1.597 mols KH₂PO₄, 0.693 mol K₂HPO₄, 0.315 mol [NH₄] ₂HPO₄ and water. The pH of the solution can be controlled through manipulation of the ratios of these components. By manipulating the ratios of the resulting H₂PO₄⁻ and HPO₄²⁻ ions, the solution can be created in a preferred pH range of about 6.0 to about 8.0.

In a preferred embodiment, KH₂PO₄, K₂HPO₄, [NH₄]H₂PO₄ [NH₄] ₂HPO₄ and water are created into the phosphorus containing parent solution. One example of a preferred embodiment is 0.3 wt % phosphorus in the solution which is added directly to injection water in a suitable manner. Upon addition to the injection water, the phosphorus content can be in the range of about 50 to 150 ppm by weight and nitrogen between about 400 and 700 ppm by weight. Higher or lower amounts may also be useful.

### EXAMPLE 1

An inorganic phosphorus and nitrogen containing aqueous parent solution was prepared by mixing glacial acetic, phosphoric acid and water. A separate aqueous solution of potassium hydroxide and ammonium hydroxide was also prepared. The aqueous base solution was then added to the acidic solution as rapidly as possible so as to generate a strong exotherm. After the exotherm had subsided the pH was adjusted with more acetic acid to a pH of about 7.0. The final weight ratio of the components was 0.25 phosphoric acid, 0.26 potassium hydroxide, 0.13 ammonium hydroxide, 0.06 acetic acid and 0.30 water. The resulting product of this reaction is useful as the chemical addition component to enhance the injection water used in secondary oil recovery.

### EXAMPLE 2

The following example was prepared in accordance with the procedure for preparing Example 1 in which another alkali metal, namely sodium, is used as the cation. The mixture of Example 2 is also effective.

| Component | g-moles | g/g-mole | Weight, g |
|---|---|---|---|
| NaH₂PO₄ | 1.597 | 1.22 | 194.8 |
| Na₂HPO₄ | 1.008 | 145 | 146.2 |
| NaOH (50%) | 1.256 | 40 | 100.5 |
| NaAc | 0.289 | 83 | 24.0 |

### EXAMPLES 4-10

The following examples were prepared in accordance with the procedure for preparing Example 1; however, (NH₄)₂HPO₄ can be replaced with (NR₄)₂HPO₄ in which R is an alkyl group so that (NR₄)₂HPO₄ is dibasic tetraethylammonium phosphate, monobasic tetraethylammonium phosphate, tetramethylammonium phosphate, tetrapropylammonium phosphate, tetrabutylammonium phosphate, trioctylmethylammonium phosphate, or tricaprylmethyl ammonium phosphate.

### EXAMPLE 4

1.597 mols KH₂PO₄

0.693 mol K₂HPO₄

0.315 mol N(CH₂CH₃)₄]₂HPO₄ (dibasic tetraethylammonium phosphate)

0.289 mol [NH₄]C₂H₃O₂

### EXAMPLE 5

1.597 mols KH₂PO₄

0.693 mol K₂HPO₄

0.315 mol monobasic tetraethylammonium phosphate

0.289 mol [NH₄]C₂H₃O₂

### EXAMPLE 6

1.597 mols KH₂PO₄

0.693 mol K₂HPO₄

0.315 mol tetramethylammonium phosphate

0.289 mol [NH₄]C₂H₃O₂

### EXAMPLE 7

1.597 mols KH₂PO₄

0.693 mol K₂HPO₄

0.315 mol tetrapropylammonium phosphate

0.289 mol [NH₄]C₂H₃O₂

### EXAMPLE 8

1.597 mols KH₂PO₄

0.693 mol K₂HPO₄

0.315 mol tetrabutylammonium phosphate,

0.289 mol [NH₄]C₂H₃O₂

### EXAMPLE 9

1.597 mols KH₂PO₄

0.693 mol K₂HPO₄

0.315 mol trioctylmethylammonium phosphate

0.289 mol [NH₄]C₂H₃O₂

### EXAMPLE 10

1.597 mols KH₂PO₄

0.693 mol K₂HPO₄

0.315 mol tricaprylmethyl ammonium phosphate

0.289 mol [NH₄]C₂H₃O₂

While the invention has been shown or described in only some of its forms, it should be apparent to those skilled in the art that it is not so limited, but is susceptible to various changes without departing from the scope of the invention. For example, [Y]H₂PO₄, [Y] ₂HPO₄ also encompasses [Y][H₂PO₄]_{z}, [Y] ₂ [HPO₄]z where z is variable integers. Moreover, those skilled in the art will appreciate that the invention described above is susceptible to variations and modifications other than those specifically described. It is understood that the present invention includes all such variations and modifications, which are within the spirit and scope of the invention. It is intended that the scope of the invention not be limited by the specification, but be defined by the claims set forth below.

We claim:

1. A process for enhancing secondary oil recovery comprising the steps of:
adding an amount of an oil recovery additive to an injection fluid to create an enhanced injection fluid, the amount of oil recovery additive being effective to enhance secondary oil recovery from a strata, the oil recovery additive comprising a mixture of salts and a dispersion fluid, the mixture of salts comprising:
[Y]H₂PO₄; and
[Y] ₂HPO₄, wherein [Y] is a cation, the dispersion fluid being operable to maintain the salts within the dispersion fluid in at least a partially dispersed state, injecting the enhanced injection fluid into the strata; and,
recovering oil from the strata.

2. The process of enhancing secondary oil recovery of claim 1 wherein the oil recovery additive further comprises [NR₄]H₂PO₄ wherein R is selected from the group consisting of hydrogen, alkyl groups and combinations thereof.

3. The process of enhancing secondary oil recovery of claim 1 wherein the oil recovery additive further comprises [NR₄] ₂HPO₄ wherein R is selected from the group consisting of hydrogen, alkyl groups and combinations thereof.

4. The process of enhancing secondary oil recovery of claim 1 wherein the oil recovery additive further comprises an organic acid anion.

5. The process of enhancing secondary oil recovery of claim 4 wherein the organic acid anion contains 5 or fewer carbon atoms.

6. The process of enhancing secondary oil recovery of claim 5 wherein the organic acid anion is acetate.

7. The process of enhancing secondary oil recovery of claim 1 wherein the pH of the salts in the dispersion fluid is between about 6.0 and 8.0.

8. The process of enhancing secondary oil recovery of claim 1 further comprising a carrier fluid such that the addition of the oil recovery additive and carrier fluid is operable to produce a water in oil emulsion.

9. The process of enhancing secondary oil recovery of claim 8 wherein the water in oil emulsion is dehydrated to create a particle dispersion oil recovery additive.

10. An enhanced injection water comprising injection water and an oil recovery additive, the oil recovery additive comprising a mixture of salts and a dispersion fluid, the mixture of salts comprising:
[Y]H₂PO₄; and
[Y] ₂HPO₄, wherein [Y] is a cation, the dispersion fluid being operable to maintain the salts within the dispersion fluid in at least a partially dispersed state, the enhanced injection water being operable to enhance oil recovery.

11. The enhanced injection water of claim 10 wherein phosphorus content of the injection water is from 1 to 10,000 ppm phosphorus.

12. The enhanced injection water of claim 10 wherein the phosphorus content of the injection water is from 50 to 150 ppm.

13. The enhanced injection water of claim 10 wherein the nitrogen content of the injection water is between 1 to 10,000 ppm by weight.

14. The enhanced injection water of claim 10 wherein the nitrogen content of the injection water is from 400 to 700 ppm by weight.

15. The enhanced injection water of claim 10 wherein the oil recovery additive is dispersed in carrier fluid to create a water-in-oil emulsion.

16. The enhanced injection water of claim 15 wherein the water-in-oil emulsion is dehydrated to produce a particle dispersion oil recovery additive.

17. An enhanced injection fluid comprising injection water and an oil recovery additive, the oil recovery additive comprising reaction products from mixing of a source of phosphoric acid, an alkali metal hydroxide, ammonium hydroxide and water, the oil recovery additive being operable to increase oil recovery in secondary oil recovery.

18. The enhanced injection fluid of claim 17 wherein the oil recovery additive further comprises acetic acid.
